(19) United States
(12) Patent Application Publication
(10) Pub. No.: US 2022/0309594 A1
(43) Pub. Date: Sep. 29, 2022

(54) Social Network System with Diversity Settings

(71) Applicant: Scott C. Harris, San Diego, CA (US)

(72) Inventor: Scott C. Harris, San Diego, CA (US)

(21) Appl. No.: 17/655,850

(22) Filed: Mar. 22, 2022

Related U.S. Application Data
(60) Provisional application No. 63/165,599, filed on Mar. 24, 2021.

(51) Int. Cl. G06Q 50/00; G06F 16/335; H04L 9/00

(52) U.S. Cl. CPC G06Q 50/01; G06F 16/337; H04L 9/50

(57) ABSTRACT

A social network uses a crowd analysis, which requires analyzing both the crowd and analyzing the posts. The crowd is analyzed to determine their diversity characteristics, and the posts are analyzed by requiring that multiple people having different diversity characteristics analyze the posts. The posts are stored as part of a blockchain so that different users can use their own stylesheets to get the information in a desired format.

This application claims priority from Provisional Application No. 63/165,599, filed Mar. 24, 2021, the entire contents of which are herewith incorporated by reference.

### BACKGROUND

Social network systems have conventionally been run by a company, such as Facebook, or Twitter. The company has a management, and the management sets rules. The rules are used to what items that are posted to the site, herein referred to generically as “posts”, are acceptable and what items aren't.

In some situations and circumstances, this is quite appropriate. For example, if a social network system is intended to be “family-friendly”, then most reasonable minds could agree on whether the platform should include pornography, or other non-family-friendly items. However, when it comes to political issues, things aren't so straightforward.

Some of the large social networks have prevented certain points of view from being advanced on their platform. Many argue that this is a political decision, and that many of these large social network sites are advancing their political agendas when they allow certain points of view and don't allow others.

### SUMMARY OF THE INVENTION

The inventor recognizes that a content neutral system should still have rules about what can be posted. However, the rules on what can be posted are inherently political. When management makes decisions such as this, they are inherently taking a political stand. That stand will be agreed with by some, and not agreed with by others.

According to embodiments, a database of information is formed for a social network system. The social network system can be any kind of system that accepts posts of any type including person's opinions, photos, videos, multimedia items, and any other kind of information from users to be shared with other users. The database forms, in general, all of the posts.

The database is shared with the users, and each user, in general, receives a subset of this database. The subset of the content that is received is based on filters set by the user, and adaptively modified by the system as the operation continues.

In one embodiment, the database is a blockchain that uses a distributed ledger system to share the blockchain among multiple different sources, and mirrored among many users using a distributed ledger to maintain its authenticity.

In another embodiment, the system uses various techniques to determine a diversity setting for a user. The diversity setting is based on information obtained from a number of different sources including sources outside the specific confines of the social network system. The diversity setting represents, among other things, the user's race, socioeconomic class, background, and political views.

The user can carry out judgments of different content on the system. Those judgments are associated with the user's diversity setting. The judgments are thus correlated with various diversity settings, rather than being correlated with users individually. A judgment may be used to set parameters of content that is provided to different users. A judgment can also be used to ban content entirely from the site, or to mark the content as being less relevant and thus either harder to retrieve, or more “expensive” to retrieve. The term “expensive” is used to represent the renumeration provided by the user in return for receiving the data. This renumeration may be an actual fee paid, an advertisement viewed or otherwise perceived, or any other way that the user can provide something in return for the data that was served.

In one embodiment, both the users and the posts are evaluated. The users are evaluated to determine their diversity characteristics, that is who they are, where they are from, what they like and dislike, and other personal characteristics. Each person is unique, however each person will be characterized in a way that fits them into a specific category of diversity.

In one embodiment, the users can ask to be provided information which is appropriate to their diversity characteristics.

In addition to the users being evaluated, the posts are evaluated. Different users can evaluate different posts for like and dislike, and to provide additional information about the post.

A post is “demoted” to be put in a condition where it is seen less often by users or made less relevant. A post is demoted when it is found distasteful or not liked by multiple different parties having multiple different diversity characteristics.

### BRIEF DESCRIPTION OF THE DRAWINGS

In the Drawings:

the figures show aspects of the invention, and specifically:

FIG. 1 shows a block diagram of the system;

FIG. 2 shows a flowchart of operation of determining characteristics;

and

FIG. 3 shows a flowchart of operation of using the social network.

### DETAILED DESCRIPTION

The present application describes a system for using a computer-based system for creating content that can be used to effect a social network system, which allows people to view and obtain other's views of content according to the system described herein.

As one embodiment, the content is included in a blockchain that is stored among multiple different parties using a distributed ledger, and users receive some content of this blockchain based on filtering characteristics which are both set by the user and also determined by the system based on actions of the user.

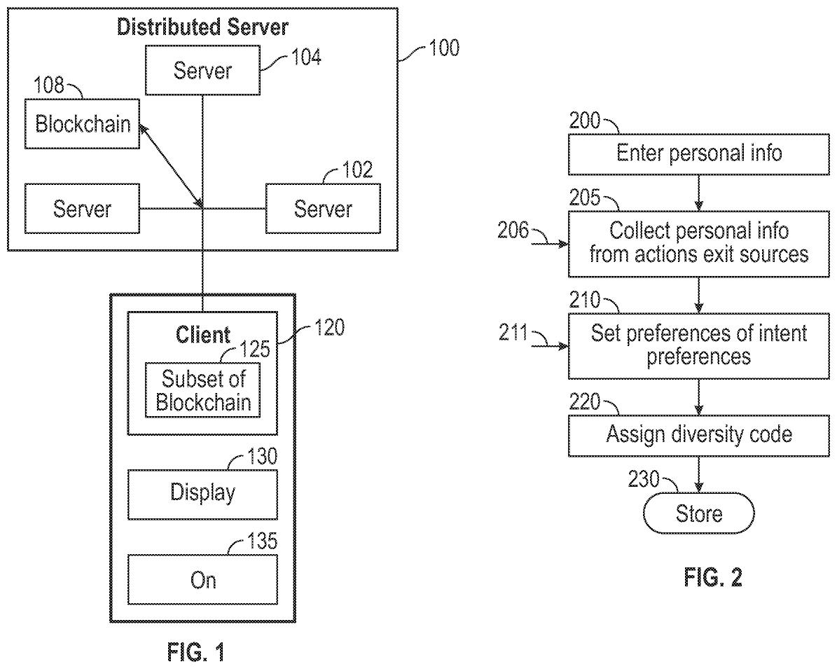

An embodiment is of the hardware is shown in FIG. 1. A distributed server 100 refers to a series of interconnected servers, including 102, 104 and others, storing and marrying mirroring one or more blockchains/databases. The blockchain can be mirrored among multiple different servers using a distributed ledger or using any other known system. This may preferably use a proof of stake consensus mechanism to mine the tokens that are used as part of the blockchain, although any existing token system, including Ethereum tokens and bitcoin cash tokens can be used.

The multiple servers can be cloud servers or any other kind of servers storing this information. The information in the blockchain is provided to client computers, who can also be servers in the sense that each client computer is also storing some subset of the blockchain locally. Each client, such as 120, is shown receiving and hence storing this subset of the blockchain 125 and hence can serve some or all of the subset that it has stored to other client computers. The client computer also includes a display 130 and a user interface 135, through which the data is displayed.

The data is obtained and displayed in a special format as described herein, which, as programmed, renders this a special-purpose computer carrying out special functions as described herein. These functions cannot be carried out by a general purpose computer without the techniques of the present disclosure.

In order to carry out the functions, an initial operation as shown in FIG. 2 is first started. At 200, the user enters their personal information. This may include all the different information about the person, including their age, race, height, weight, political affiliation, and other information which may be relevant to this kind of social network system.

In addition to entering the information at 200, other information is also automatically collected at 205. The collection of information is carried out both from the user's actions on the site, and from external sources. Each time the user take some action on the site, their personal information may be affected by the action on the site, shown as 206. The external sources may be monitoring publicly available sources of information, or other social networks, or any action a user is taken that is available on the Internet.

At 210, the user sets preferences, for example what things they might be interested in. The user can later change these. The system also infers other preferences, from actions taken on the site, shown generically as 211.

At 220, the user is assigned a diversity code. The diversity code can just be a number or an alphanumeric sequence that represents a category that the user falls into, or can include the information itself for example a feature vector which takes into account many different aspects of diversity.

The aspects of diversity may include socioeconomic class, race, political affiliation, and other information. In an embodiment, at least one aspect of the diversity code is automatically determined by the system through actions of the user, and/or through actions the user takes on other sites.

All of this information is stored at 230, and can be stored as part of the blockchain, or can be stored as the user's personal information/profile.

When the user chooses to view items, the user is viewing content that was obtained from the blockchain 108. What this means is that the viewing software on the users client 120 is parsing the information in the blockchain and deciding how it should look when displayed. The information in the blockchain is in essence the database, and the display is controlled by the software that is interpreting the information. The displaying software or app can in essence act as a stylesheet for the information in the blockchain. In many ways, this can be analogous to a sort of open source system. Anyone who gets the information 108 can display it using their own personal client form. This means that the information 108 can be displayed in various different ways, based on a personalized stylesheet determined by the user.

In an ideal world, a blockchain system would be completely distributed, and no one would get any money for doing anything. In the real world, however, different parties within the blockchain system obtain bounties for doing different things.

In this embodiment, the blockchain storage people may obtain certain fees as bounties for serving the information to others. For example, the system may require that a user watch an advertisement for every predetermined data packet of information they receive. As described herein, however, different data packets may have different expenses, some data packets may be more expensive than other data packets. A standard cost data packet may require the user to watch a 20 second commercial for every 20 MB packet of information they receive. However, other data packets, and especially those which have been marked less relevant and hence are more difficult to obtain (because they are stored by fewer servers), may require the user to watch this 20 second commercial for only a 1 Mb packet of information being received.

In other embodiments, since the client is also storing information, the client can send that information to others, and may receive credit for sending that information, which credit is applied against the expense that they incur for getting new information.

Alternatively, users can be billed directly, it being understood that a debit and credit system can be assigned, where the more information the client stores, the less of the information they need to download, and the more of that information that the client can serve to others, and therefore the less renumeration that they may need to provide. Moreover, some data is more expensive than other data. The term renumeration is used herein to refer, in general, to something paid as a bounty to some other conveyor of data information. Again, this renumeration can be cash, advertising participation, or data provision, as well as any other way of providing renumeration.

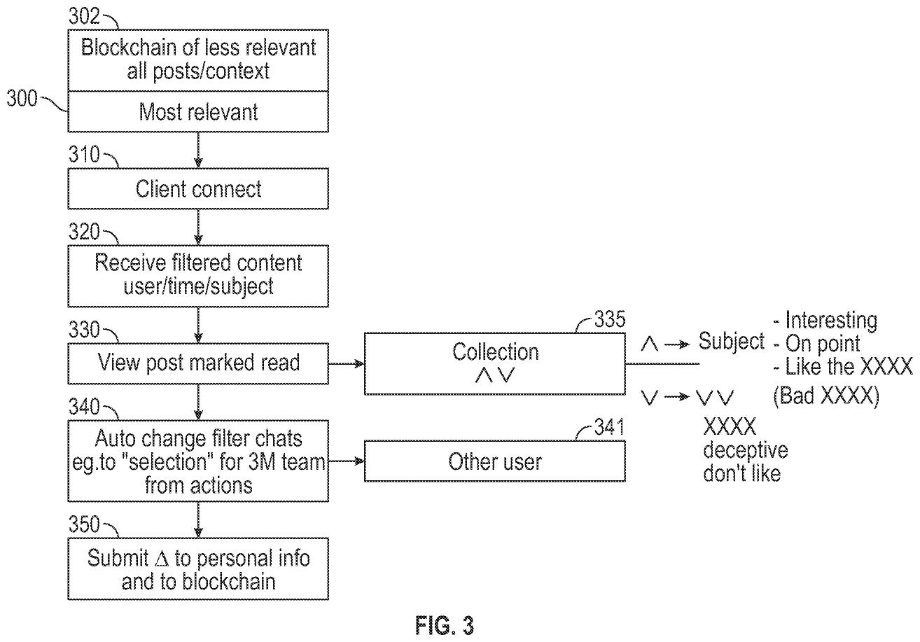

FIG. 3 represents the main flowchart of operation of receiving the information. In one embodiment, the blockchain of information may be categorized. One category is most relevant, which is information that is most often requested or received by clients. The most relevant blockchain information is shown is 300. There is also, another part 302 referred to as the less relevant blockchain information. Collectively, this may include everything that has ever been stored, including all posts and content.

At 310, the client connects to the distributed server, to receive the blockchain information. The filter settings are used to filter the overall information so that the client only receives filtered information at 320. Filtering can include, for example, recipients or sender, such as users who have sent the information, time that the information was sent, subject of the information, machine determined relevance of the information, popularity globally, and/or popularity by my diversity rating.

Initially at least, the user may receive filtered content for people they “follow”, within a certain time period of having been sent (for instance a month,) and also may receive the machine determined relevant most relevant information based on the preferences and diversity code for the user.

At 330, the user views the content. Each item of content may be referred to as a post, although it may not be a post in the usual sense, it is still an item of information.

Once the item is viewed, is marked by the system as read. Posts which are read automatically become less relevant to the specific user. In addition, the amount of time that the user views the post, the number of times the users returned to the post, the number of forwards or replies, are monitored at 335 as additional fine tuning for the relevance of the post both to the user, and globally.

Users can comment on posts. The comments can include like comments and dislike comments. The like, shown generically as a \hat{ }, represents the user signifies that they like the post. Once so signifying, with different opportunities to say why they like it, and uses that information to help decide which other kinds of posts should be deemed relevant to the user (as well as, as described herein using this to set the users diversity characteristics).

For example the user can say that a post is interesting, or ‘on point’ to add to a like, or that they like the author, or that they like the style, or that they like the colors or that they like anything else about the post. For thumbs down or v, the user may be given the option of 2 thumbs down ∨ ∨, meaning that this is very bad information, that it is porn, deceptive, don't like it, not true, or others. That is, the user can use the thumbs up and thumbs down to indicate that a post is something they want to see more of, or opposed to something that they want to see less of. The filter characteristics are automatically changed at 342 go along with this. When the user likes a post, characteristics of that post are used to figure out more things the user might like. For example, other users who have the same or similar diversity characteristics to the user likes a post, at 341, the system determines posts that other or determined characteristics of other users who have liked that post. Similarly, when a user dislikes a post, this is compared with diversity characteristics of other users who disliked the post.

Based on this the system learns from the post information, and the user's likes and dislikes, reasons for likes and dislikes tries to determine how to modify the users diversity score based on the users action. That is, the users diversity score may also be modified by their likes and dislikes, to make their diversity score closer to diversity scores of other users who have liked and disliked similar posts.

The user can of course be deceptive when they post information about themselves. This may be intentional deception or unintentional deception. However, the user will not typically say that they like and dislike things that they do not like and dislike. And if they do, then they are playing the part of someone that they are not, get an appropriate diversity score for the part they are playing. Based on all this information, changes to the personal information, the diversity score, and the blockchain are provided at 350.

In embodiments, different posts can be modified, or set to be less relevant, if multiple people having diverse diversity scores all dislike the post. For example, if people from 10% of all diversity scores all say that there is something wrong with the post, this can be used to lower the score of the post, for example to put it in the less relevant category, to lower the score for the user, or to lower the score for everyone, so that the post becomes harder to get, and hence more expensive to get.

As described above, bounties are paid to the system. In one embodiment, posts which are more relevant are stored by multiple different categories, and hence there is a lower bounty. Posts which are less relevant are stored by less people, and hence may be require a higher bounty. When posts become less relevant, like a lot of them are flagged as being irrelevant, incorrect, by a wide diversity of people, then they are made less relevant, and require more effort on the part of the user to be viewed. If something is even worse, however, it could be banned entirely.

Other features are as follows:

Many apps can use their own stylesheet to display the information because in essence the information is open source.

In one embodiment, some or all of the information can be stored in an encrypted or encoded form, and users may be forced to watch and and before the data encrypts or decodes.

In one embodiment, the judging tools 335, can include one different option saying I thought I had already asked not to receive this stuff. This is an indication that the step should be used to set the preferences even further, at 211.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A post displaying system, comprising:
a memory storing a database of posts to be viewed by users;
a computer, operating to access the memory, and operating to display said posts to said users, and to receive actions taken by the users to interact with the posts,
the computer accepting first information entered by a user to represent characteristics of the user, and monitoring actions taken by the user on the computer to determine second information,
the computer filtering the posts based on both the first information and the second information, to select only selected ones of said posts from the database based on both the first information and the second information and displaying the selected ones of the posts to the user received based on the filtering.

2. The system as in claim 1, wherein the computer operates to assign a diversity code to the user based on both said first information and said second information, and where the computer filters the posts based on the diversity code.

3. The system as in claim 2, wherein the diversity code is an alphanumeric sequence that represents a category that the user falls into based on both said first information and said second information.

4. The system as in claim 2, wherein the diversity code is a vector file which has elements that include the first and second information about the user.

5. The system as in claim 2, wherein the diversity code takes into account at least socioeconomic class, race, and political affiliation, which is at least partly automatically determined by the system based on the second information.

6. The system as in claim 2, wherein the second information is determined by the computer by analyzing the user's actions in interacting with other websites on the computer.

7. The system as in claim 2, wherein the computer carries out the filtering based on all of a specific user who has sent the information to be stored in the database, a time that the information was sent, a subject of the information, a machine determined relevance of the information, popularity globally, and popularity by the user's diversity rating.

8. The system as in claim 1, wherein the computer carries out the filtering based on a relevance determined using all of an amount of time that users views the post, a number of times that users return to the post, and a number of forwards or replies to the post.

9. The system as in claim 2, wherein the computer displays information enabling the user to like or dislike the post, and uses the likes and dislikes as part of the determination of the diversity rating.

10. The system as in claim 2, wherein the computer carries out the filtering based on a relevance, and where posts have their relevance changed when multiple different users with multiple different diversity settings all either like or dislike a same post.

11. The system as in claim 2, wherein the database that is stored in a blockchain that is mirrored among many users using a distributed ledger, and the computer acts as a stylesheet to display information in the database.

12. A computer system filtering and serving a plurality of posts to a user, comprising:
a database, which receives and stores posts from users, and serves the post to other users;
a computer which determines characteristics of different users, and determines a diversity setting for each user, and stores the diversity setting, where the diversity setting includes information about political beliefs of the each user, the diversity setting determined based on monitoring actions of the each user,
and where the computer uses the diversity setting to filter the posts in the database and determine which posts should be sent to a specific user based on their diversity setting.

13. The computer system as in claim 12, wherein the computer also accepts ratings of the posts by other users, and assesses relevance of the posts based on the ratings by the other users, where a post is made more relevant when multiple users of multiple different diversity settings indicate interest in the post.

14. The computer system as in claim 12, where the computer requires users to provide renumeration for each post that is viewed, and the renumeration being based on a relevance of the post.

15. The computer system as in claim 14, where posts which are more relevant to multiple different diversity categories require a lower renumeration.

16. The computer system as in claim 14, wherein posts which are less relevant require a higher renumeration.

17. The computer system as in claim 14, wherein the database that is stored in a blockchain that is mirrored among many users using a distributed ledger, and the computer acts as a stylesheet to display information in the database.

18. The computer system as in claim 14, wherein the renumeration is an amount of time of advertisements that must be viewed.
